(19) United States
(12) Patent Application Publication
(10) Pub. No.: US 2016/0216181 A1
(43) Pub. Date: Jul. 28, 2016

(54) METHOD AND SYSTEM FOR ARTIFICIAL AGEING, AND DETERMINING EFFECTIVE ARTIFICIAL AGE OF PRODUCT

(71) Applicant: R. Scott Vincent, Draper, UT (US)

(72) Inventor: R. Scott Vincent, Draper, UT (US)

(21) Appl. No.: 14/606,994

(22) Filed: Jan. 27, 2015

(51) Int. Cl. G01N 1/44; C21D 1/00; G01N 25/00; C22F 1/00

(52) U.S. Cl. CPC G01N 1/44; C22F 1/00; C21D 1/00; G01N 25/00

(57) ABSTRACT

A system for ageing of product artificially, including methods and devices is provided that allow for the control of product being artificially aged and also allow for the determination of artificial age and effective artificial age of product being subjected to an artificial ageing environment.

### CROSS REFERENCE

This application claims priority of U.S. Provisional Application No. 61/965,326, filed on Jan. 27, 2014, and the entirety of which is incorporated by reference herein.

### TECHNICAL FIELD

The present invention concerns a system for ageing of product artificially, including methods and devices for same.

### BACKGROUND

Ovens have been used to artificially age product by placing product within the oven at constant elevated temperatures for a duration in order to simulate the time related, or other, degradation. Such systems are not precise and lend themselves to inaccuracies in formulating information needed to establish the equivalent age of the artificially aged product. The artificially aged information being necessary to establish product claims, to write reports, and to comply with laws, such as medical device regulations contained in 21 C.F.R.

Accordingly, a system for ageing of product artificially, including methods and devices for same is needed.

### SUMMARY

A system for ageing of product artificially, including methods and devices is provided that allow for the control of product being artificially aged and further allows for the determination of artificial age and effective artificial age of product being subjected to an artificial ageing environment(s), episodes, duration(s) and/or changing conditions.

In one embodiment, a system for ascertaining the artificial age of a product includes determining the artificial age of product being subjected to one or more exposure episodes from data. And may further include determining the effective artificial age of product by summing the artificial age of the product with the one or more periods of not artificially ageing the product. The data comprising at least one of time, temperature, atmospheric pressure, humidity, electromagnetic radiation and chemical environment.

In another embodiment, a method for ascertaining the artificial age of a product, includes collecting data, and determining from the data the exposure over the duration of exposure for each of one or more periods of time and summing to the periods of time lapsing there between, before and after each of one or more artificial aging episodes.

In another embodiment, a unique artificial age identifier is provided for control of the product during artificial ageing that includes at least one of a condition code or a duration code, and a removal code.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 provides a system for ascertaining the artificial age of a product, and further includes control of product during artificial ageing using a unique artificial age identifier.

FIG. 2 provides a unique artificial age identifier.

### DETAILED DESCRIPTION OF THE PREFERRED EMBODIMENT

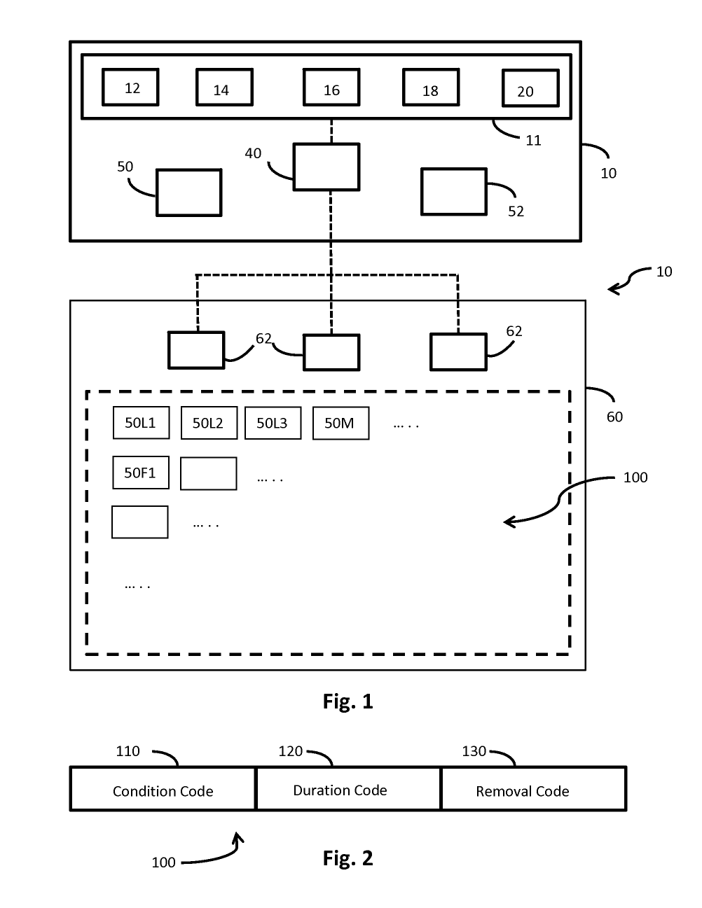

A system for ageing of product artificially, including methods and devices is now presented. Reference to FIGS. 1 and 2 may be made throughout the description.

A system 10 for ascertaining the artificial age of a product includes a computer system 11 for inputting data, storing data, retrieving data, manipulating data, reporting data, determining the artificial age 50 of the product from the data, and determining the effective age 52 (artificial age and actual age) of the product. The system may also include reporting the exposure level to the product associated with the data.

The computer system 11 may include input devices 12, such as key boards, touch pads, analog A/D converters, visual input displays, and other input devices, without limitation. The input devices allowing use of the computer system and associated programs to determine artificial age of the product.

The computer system may include output devices 14, such as visual displays, printers, peripherals, without limitation. The output devices allowing use of the computer system and associated programs to determine, monitor and report artificial age of the product.

The computer system may include storage devices 16, such as RAM, ROM, and computer readable mediums, without limitation. The storage devices for receiving, storing and recalling information related to the data 40 collected by the system 10.

The computer system may include processors 18, such as a CPU, without limitation, for accessing memory and processing memory, the memory containing data 40.

The computer system may include a standalone processing unit, such as a laptop computer, or may include a series of one or more processing units interconnected (wirelessly, physically, remotely) to one another, or may include a network, such as an internet or intranet, all of which may be communicable with each other in any combination suitable for embodiments of the invention and implementing embodiments of the invention. In this respect, other computer systems and memory, such as a cloud, may be used without limitation.

The computer system having one or more executable programs 20 for receiving and processing the inputted data 40, processing the stored data, processing the retrieved data, processing and manipulating the data 40, and processing for reporting the data.

Data, without limitation, is information containing the state, or states, of time, temperature, atmospheric pressure, humidity, electromagnetic radiation (visible, UV, or other) and/or chemical environment, in any combination for determining artificial age of a product. The data being recorded or stored as a measurement or value, representatively. Time is indicative of a moment and/or a date. Data may be collected on any time interval (constant or irregular), such as by the minute, hour, day, or event (i.e., opening or closing the chamber, power outage . . . ).

Data, the state or states of which, may be obtained discreetly at a particular time or discreetly over multiple periods of time. Data, the state or states of which, may be continuously collected, averaged, or weighted using mathematical or statistical methods, and reported representing the values (or value) for a discrete or continuous number of measurements taken over a time frame, a chosen time frame or a defined time frame. Time frame may also include periods of time, segments of time, and episodes. Also, data, the state or states of which, may be discreetly collected, averaged, or weighted using mathematical or statistical methods, and reported representing the values (or value) for a discrete number of measurements over any time frame, a chosen time frame or a defined time frame. Thus use of the data is without limitation regardless of the method or manner in which the data is collected or obtained.

Data 40 is received from one or more sensors capable of measuring the state of the data desired, i.e., measuring or determining the value of time, temperature, atmospheric pressure, humidity, electromagnetic radiation (visible, UV, or other) and/or chemical environment from a chamber 60 at any moment. The data may be collected, i.e., recorded and/or stored, electronically or physically. A chamber may be a closed system, such as an environmental chamber for accelerating aging of a product using elevated temperature or chemical exposure, or an open (or open/closed) controlled space such as for ultraviolet irradiating a product to artificially age a product due to ultraviolet exposure. Chamber is not limited to any particular structure, but is indicative of a controlled open or closed space used for ageing of product.

The data, as obtained, may be used for determining the remaining duration in which the product is being artificially aged, and/or for determining the artificial age of the product thus age so far. In one respect, the data may be used by the computer system to control the chamber (starting or stopping the artificial aging), to control the extent to which the product is to remain in the chamber, and/or to give notice when the product is to be removed from the chamber. Product placement into and out of the chamber may be automatic, e.g., robot, or non-automatic, such as by a person moving the product.

An artificial age program (may be implemented/executed systematically by use of the data collected by the computer system or manually entered therein) may receive the data for reducing and determining the artificial age of the product while in the chamber. The artificial age being determined using and executing scientific routines and applying principles for artificial age determination. For example, product may be artificially aged by placing the product into a chamber using an increased temperature, such as 50 Deg. C., for a set duration. The product's artificial age being determined from the temperature exposure over the duration of exposure.

An artificial age program (may be implemented/executed systematically by used of the computer system or manually) may receive the data for reducing and determining the effective age (artificial age and actual age) of the product. The effective age being determined by using and executing scientific routines and applying principles for artificial age determination while being artificially aged and adding actual age durations to the artificial age. For example, product may be artificially aged by placing the product into a chamber using an increased temperature, such as 50 Deg. C., for a set duration for one or more periods of time. The product's artificial age being determined from the temperature exposure over the duration of exposure for each of the one or more periods of time and summed to the periods of time lapsing between, before and/or after each of the one or more artificial aging episodes.

Artificial aging episodes may include a single constant exposure to an artificial aging condition for a set duration. Artificial aging episodes may include one or more exposures to artificial aging condition(s). The conditions may be constant, stepped, stopped/started, and/or variable over time allowing the artificial ageing system to determine the effective and/or actual artificial age of the product due to steady-state and or varied states within the chamber. The embodiments of the invention allowing for planned accelerating episodes, unplanned, downtime, and/or changing the accelerated ageing rate without loss of information regarding the accelerated age and effective accelerated age of the product.

For example, product is received by the artificial ageing system on a date at a time. The product is placed into the chamber to be artificially aged. While in the chamber the product is exposed to the artificial ageing conditions during one or more episodes. The product while in the chamber is monitored by collecting the data pertinent to the artificial ageing conditions for artificially ageing it appropriately. The product is then removed from the chamber and returned. The artificial age of the product being determined by the duration and conditions experienced by the product during the one or more episodes, the artificial age of the product being determined by using the data 40. The effective age of the product being determined by summing of the time lapse(es) before, during and/or after artificial ageing when the product is not being artificially aged together with the reduced artificial age of the product while being artificially aged.

Embodiments of the invention allow for product to be transmitted for artificial ageing and returned from artificial ageing with determinate information as to the effective artificial age of the product due to the lapse of time from when the product is sent out and returned from the artificial ageing system. Moreover, by summing the one or more periods in which the product is artificially aged (in steady state, stepped and/or variably aged) together with the actual age of the product between artificially ageing periods allows for objective evidence of true effective age of a product. Furthermore, such a system allows for changing the ageing plan (increasing and/or decreasing the ageing rate during artificial ageing) while maintaining the ability to determine the actual artificial age and, thus, the effective artificial age of the product.

In another aspect of the system, the data can be reported showing the exposure level to the product before, during and after artificial ageing episodes, thus supporting the determination of artificial age and/or effective artificial age of the product. The reporting of exposure level may include additional indicia supportive of the conditions under which the artificial ageing occurred, such as, for example, the level of humidity, expressed as relative humidity or expressed in ppm of water moisture, without limitation. The exposure level may be any of the conditions, i.e., time, temperature, atmospheric pressure, humidity, electromagnetic radiation and/or chemical environment.

Artificial ageing tables and equations recognized by industry are incorporated into this disclosure by reference.

The system, in an embodiment of the invention, includes a method for the deterministic induction and removal of product to be artificially aged in a chamber. For example, product received from different sources or for different products may be desirably aged, e.g., 1 month, 1 year, 2 years, 3 years, 5 years . . . , without limitation, for different artificial ageing durations and, while yet, using the same artificial ageing conditions, such as at 50 Deg. C. As such the induction into and removal from the chamber must be nearly precise in order to prevent the product from being under aged or over aged beyond an appreciable amount of time. In order to control the induction and removal of product, a unique artificial age identifier 100 is assigned each set of product being aged according to desired condition, desired effective duration, and first-in/first-out basis. The unique artificial age identifier(s) may be a color code, alpha character code, an numeric code an alpha/numeric code or a combination of the codes that allow for the deterministic identification for induction and/or removal of product from the artificial ageing chamber.

For example, five different products are received by the system all being desired to be artificially aged using an oven having a steady state temperature profile of, for example, 50 Deg. C., yet each one having different artificial age requirement and the product being received at various points in time by the system. The first product received, in this example, is desired to have artificial ageing to be equivalent to 3 years; the second, 5 years; the third, 3 years; the forth, 6 months; and the fifth, 3 years, respectively. The condition code 110 (in this example is “50”) is assigned all products to be inducted into the 50 Deg. C. chamber. The three year product is assigned duration code 120 (in this example is “L”), the 6 month product is assigned the duration code 120 (in this example is “F”), and the five year product is assigned the duration code 120 (in this example is “M”). The removal code 130 being assigned on a first in/first out basis (in this example is an ordered numeric number “1, 2, 3, . . . ” representative of first-in/first-out identifier for the particular condition code and duration code.) The unique artificial age identifier for the first product is, hence, 50L1, the second product is 50M1, the third product is 50L2, the forth product is 50F1, and the fifth is 50L3. Accordingly, the product having the artificial age identifiers are inducted into the chamber in the following order 50L1 before 50L2 and 50L3; 50L2 before 50L3; 50L3 before the next product having the same condition code and duration code; 50M1 before the next product having the same condition code and duration code; and 50F1 before the next product having the same condition code and duration code. Further, the product having the artificial age identifiers are removed from the chamber in the following order 50L1 before 50L2 and 50L3; 50L2 before 50L3; 50L3 before the next product having the same condition code and duration code; 50M1 before the next product having the same condition code and duration code; and 50F1 before the next product having the same condition code and duration code. The removal code being logically index ensures that the product is removed, in order of inductance, dependent upon the conditions and required durations. FIG. 2 shows unique artificial age identifier. FIG. 1 shows 50L1 ready for removal from the chamber 60.

In an embodiment, the removal code is a sequential numeric number ordered for the product based upon first in and first to come out. Also, the unique artificial age identifier is prominently labeled upon the containers containing the product, reference FIG. 1

It is also recognized that the condition code and the duration code can use a common code depending upon the complexities of the artificial ageing system, without limitation, the combination of which when combined together with the removal code provides for an unique artificial age identifier for each set of product. For a more complex system, the condition code and the duration code would be unique from one another.

The unique artificial age identifier may be by use of other symbols, such as a bar code, that provide for a condition code and/or a duration code together with a removal code.

Each unique artificial age identifier may be for a grouping of product, or sets or sub-sets of product, such as the individual product units or sets of product units boxed into sets of containers.

Thus, the unique artificial age identifier allows for ready identification of product to be inducted into the chamber and for product to be removed from the chamber with less concern about over or under ageing of the product because of the control provided by the identifier. It is recognized that a unique artificial age identifier may be affixed, attached, tagged or otherwise applied to the product units or groupings as is well understood in the marking and labeling art.

The system for artificial ageing of product in a controlled environment may also necessitate control of one of the data states, for example, without limitation, that of humidity during the artificial ageing of the product. By controlling humidity, a desired level of moisture content may be obtained. Humidity control may be accomplished using various means, such as the steam treatment described in U.S. Pat. No. 5,552,578, incorporated herein by reference.

An oven for ageing is presented in U.S. Pat. No. 4,695,707, incorporated herein by reference, that provides a system, method and device that may beneficially be improved by applying the present invention.

A simulation oven is presented in U.S. Pat. No. 4,137,966, incorporated herein by reference, which provides a system, method and device that may beneficially be improved by applying the present invention.

While particular embodiments of the invention have been shown and described, numerous variations and alternate embodiments will occur to those skilled in the art. Accordingly, it is intended that the invention be limited only in terms of the appended claims.

What is claimed is:

1. A system for ascertaining the artificial age of a product, comprising:
determining the artificial age of product being subjected to one or more exposure episodes from data.

2. The system of claim 1 further comprising determining the effective artificial age of product by summing the artificial age of the product with the one or more periods of not artificially ageing the product.

3. The system of claim 1 wherein data comprises at least one of time, temperature, atmospheric pressure, humidity, electromagnetic radiation and chemical environment.

4. The system of claim 1 wherein data comprises at least time and temperature.

5. The system of claim 1 wherein data is collected on any time interval.

6. The system of claim 5 wherein the time interval is by the minute.

7. The system of claim 1 further comprising determining the effective artificial age of product by summing the artificial age of the product being subjected to two or more exposure episodes with the intervening periods when not artificially ageing the product.

8. The system of claim 1 wherein the data is collected electronically from a temperature sensor within a closed system.

9. The system of claim 1 further comprising ascertaining the remaining duration in which product is artificially aged by subtracting the intended artificial age from the artificial age determined from the data.

10. The system of claim 9 further comprising changing an ageing plan in response to ascertaining the remaining duration in which product is artificially aged by subtracting the intended artificial age from the artificial age determined from the data.

11. The system of claim 1 wherein the artificial age of the product is determined programmatically.

12. The system of claim 2 wherein the effective artificial age of the product is determined by the age of the product prior to insertion into the ageing chamber summed together with artificial age of the product from a single exposure to artificial aging conditions.

13. The system of claim 1 further comprising reporting the artificial age of product after determining the artificial age of product.

14. A method for ascertaining the artificial age of a product, comprising:
collecting data, and
determining from the data the exposure over the duration of exposure for each of one or more periods of time and summing to the periods of time lapsing there between, before and after each of one or more artificial aging episodes.

15. The method of claim 14 further comprising reporting the artificial age of product after determining the artificial age of product.

16. The method of claim 14 further comprising changing an ageing plan in response to ascertaining the remaining duration in which product is artificially aged by subtracting the intended artificial age from the artificial age determined from the data.

17. The method of claim 14 wherein determining the artificial age of the product from the data is done using the Arrhenius equation.

18. An unique artificial age identifier, comprising:
a removal code, and
at least one of a condition code or a duration code.

19. The unique artificial age identifier of claim 18 comprising the removal code, the condition code and the duration code.

20. The unique artificial age identifier of claim 18 the removal code is a sequential numeric number for product induction and removal.
